(19) United States
(12) Patent Application Publication
(10) Pub. No.: US 2013/0346842 A1
(43) Pub. Date: Dec. 26, 2013

(54) PROGRAMMABLE DISPLAY DEVICE AND DRAWING-DATA CREATION METHOD

(71) Applicant: Kengo Koara, Chiyoda-ku (JP)

(72) Inventor: Kengo Koara, Chiyoda-ku (JP)

(73) Assignee: MITSUBISHI ELECTRIC CORPORATION, Chiyoda-ku, Tokyo (JP)

(21) Appl. No.: 14/000,335

(22) PCT Filed: Mar. 2, 2011
(86) PCT No.: PCT/JP2011/054769

§ 371 Date: Aug. 19, 2013

(51) Int. Cl. G06F 3/0481

(52) U.S. Cl. CPC G06F 3/0481
USPC 715/211

(57) ABSTRACT

A programmable display device that is connected to a control device controlling a plurality of devices and functions as a user interface for the control device includes an acquisition unit that acquires drawing data including class definition information having a plurality of objects linked as one composite object, an instance generation unit that generates a composite object instance according to the class definition information, and a display control unit that displays a screen corresponding to the composite object on a display unit according to the generated composite object instance, and the generated instance has the plurality of objects and a virtual device memory for instance that is cross-referenced when data is transferred among the objects.

### FIELD

The present invention relates to a programmable display device and a drawing-data creation method.

### BACKGROUND

When a function required by a user (a screen designer) of a programmable display device is not available during screen design by the user, it is necessary to combine a plurality of display objects using drawing software for screen design or to realize a desired function by using a programming function (a script) of the drawing software together.

For this purpose, a plurality of objects or scripts are associated with each other by using an internal device memory provided in the programmable display device or using a device of a unit such as a PLC (Programmable Logic Controller).

In this method, however, settings of individual objects or scripts need to be changed when the created objects are diverted or altered, and also device memory allocation without overlapping other objects is required for the association. When the size is to be changed, a method of grouping a plurality of objects and collectively scaling up or down the grouped objects is used, for example. However, this method changes the sizes of all the objects. Therefore, it is difficult to perform an operation of keeping the size of one object (a switch, for example) as it is and changing the sizes of only the other objects (a graph, for example) in a lump. Accordingly, maintainability of drawing data for screen design of the programmable display device is likely to reduce.

Furthermore, additional work is required and thus this method is likely to increase a man-hour in screen design on a user side.

### CITATION LIST

### Patent Literature

Patent Literature 1: Japanese Patent No. 4175041

### SUMMARY

### Technical Problem

To solve such a problem, every time a request from a user is received, the manufacturer of the programmable display device individually develops a function complying with the request. Accordingly, it is difficult to timely provide the function. Furthermore, if functions complying with requests are added one after another every time requests are received from users, the functions of the drawing software considerably increase and consequently the screen design becomes complicated.

There is also a case of providing sample data of a composite function without performing function development. In this case, however, it is difficult to solve the problem of diversion or alteration. That is, settings of individual objects or scripts still need to be changed to divert or alter the created object and also device memory allocation without overlapping other objects is required for association.

The present invention has been achieved in view of the above problems, and an object of the present invention is to provide a programmable display device and a drawing-data creation method that are suitable for setting a function that can be realized by a combination of a plurality of existing objects easily on a user side.

### Solution to Problem

To solve the above problems and achieve an object, there is provided a programmable display device according to an aspect of the present invention that is connected to a control device controlling a plurality of devices, and functions as a user interface for the control device, the programmable display device including: an acquisition unit that acquires drawing data including class definition information having a plurality of objects linked as one composite object; an instance generation unit that generates a composite object instance according to the class definition information; and a display control unit that displays a screen corresponding to the composite object on a display unit according to the generated composite object instance, wherein the generated instance includes the plurality of objects, and a virtual device memory for instance that is cross-referenced when data is transferred among the objects. The programmable display device also has a mechanism that specifies a positional relation and a size relation of the objects that constitute the composite object.

### Advantageous Effects of Invention

According to the present invention, in the programmable display device, in accordance with class definition information that is defined by linking a plurality of existing objects as one composite object, a screen corresponding to the composite object is displayed on a display unit. Therefore, a programmable display device suitable for setting a function that can be realized by a combination of existing objects easily on a user side can be achieved.

### BRIEF DESCRIPTION OF DRAWINGS

FIG. 1 depicts a system configuration of a programmable display device according to an embodiment of the present invention.

FIG. 2 depicts internal configurations of a drawing device, a programmable display device, and a PLC according to the embodiment.

FIG. 3 depicts a configuration of class definition information according to the embodiment.

FIG. 4 depicts a configuration of a generated composite object instance according to the embodiment.

FIG. 5 depicts a configuration of a virtual device memory according to the embodiment.

FIG. 6 depicts a configuration of a script according to the embodiment.

FIG. 7 depicts an edition screen of the class definition information according to the embodiment.

FIG. 8 depicts edition screens of the class definition information according to the embodiment.

FIG. 9 depicts edition contents of the class definition according to the embodiment.

FIG. 10 depicts edition contents of the class definition according to the embodiment.

FIG. 11 depicts a configuration of drawing data according to the embodiment.

FIG. 12 depicts a configuration of the drawing data according to the embodiment.

FIG. 13 depicts an edition screen of the drawing data according to the embodiment.

FIG. 14 depicts edition contents of the drawing data according to the embodiment.

FIG. 15 depicts edition contents of the drawing data according to the embodiment.

### DESCRIPTION OF EMBODIMENTS

Exemplary embodiments of a programmable display device according to the present invention will be explained below in detail with reference to the accompanying drawings. The present invention is not limited to the embodiments. Embodiment.

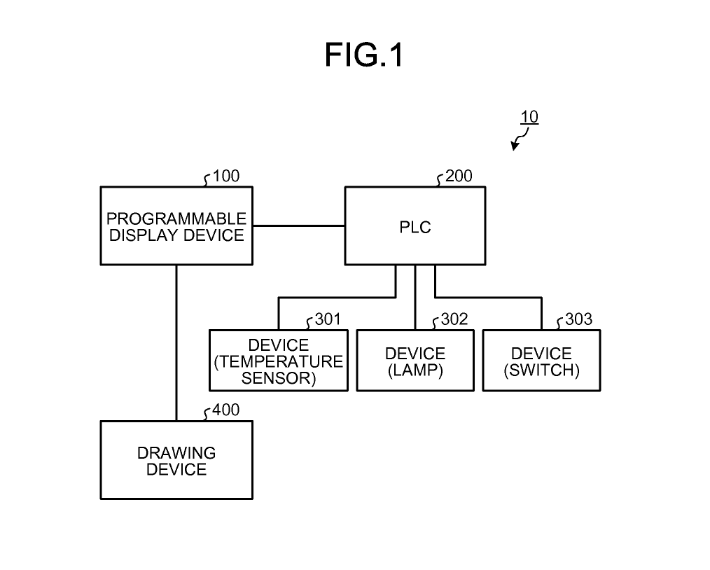

A schematic configuration of a control system 10 to which a programmable display device 100 according to an embodiment of the present invention is applied is explained with reference to FIG. 1. FIG. 1 depicts a schematic configuration of the control system 10.

The control system 10 is used to control a plurality of devices. The control system 10 includes a drawing device 400, the programmable display device 100, a PLC (Programmable Logic Controller) 200, and a plurality of devices 301 to 303. An operator in the present specification means a person operating the programmable display device 100. A user in the present specification means a screen designer who designs a screen of the programmable display device 100 via the drawing device 400.

The drawing device 400 is connected to the programmable display device 100. The drawing device 400 creates drawing data, which is design data of a screen to be displayed on the programmable display device 100, according to an operation of the user. The drawing device 400 supplies the drawing data to the programmable display device 100.

The programmable display device 100 is connected to the drawing device 400 and the PLC 200. The programmable display device 100 displays the screen designed by the drawing device 400 on a display screen according to the drawing data received from the drawing device 400. The programmable display device 100 receives an operation of the operator via the display screen, and reads data held in the PLC 200 or rewrites data held in the PLC 200 according to the operation of the operator. That is, the programmable display device 100 functions as a user interface for the PLC 200.

The PLC 200 is connected to the programmable display device 100 and the devices 301 to 303. The PLC 200 controls the devices 301 to 303.

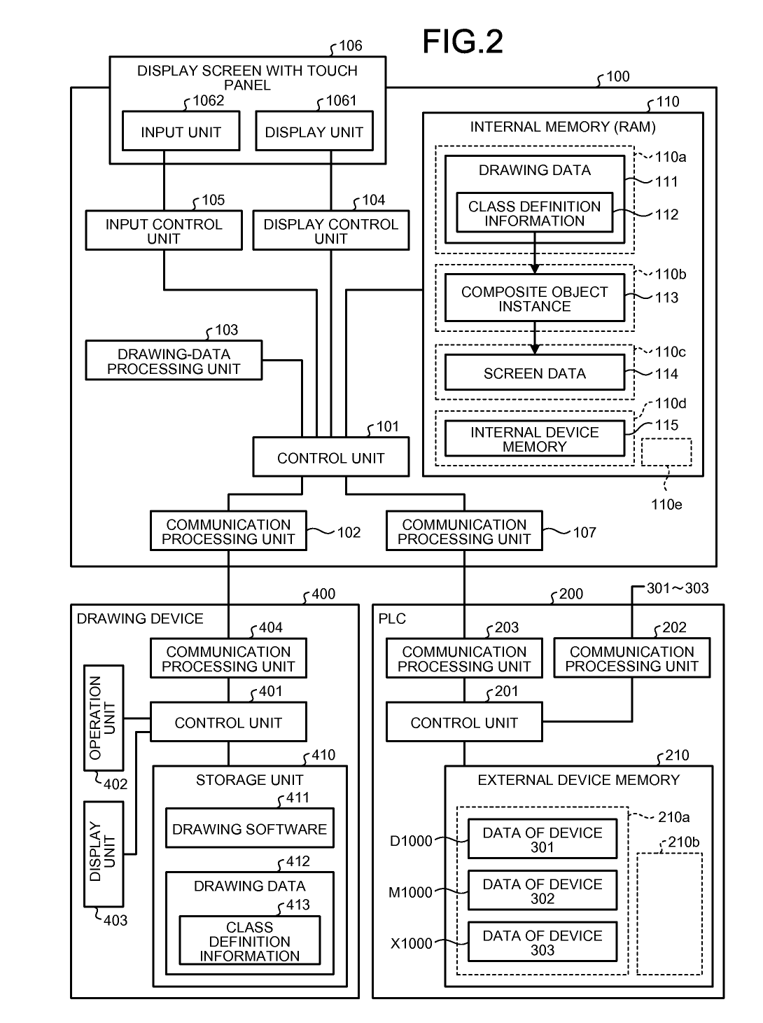

An internal configuration of the drawing device 400 is explained with reference to FIG. 2. FIG. 2 depicts internal configurations of the drawing device 400, the programmable display device 100, and the PLC 200.

The drawing device 400 has drawing software 411 installed therein, and designs a screen to be displayed on the programmable display device 100 upon receipt of an operation of the user. The drawing device 400 is a terminal device such as a personal computer. Specifically, the drawing device 400 has a control unit 401, a storage unit 410, an operation unit 402, and a communication processing unit 404.

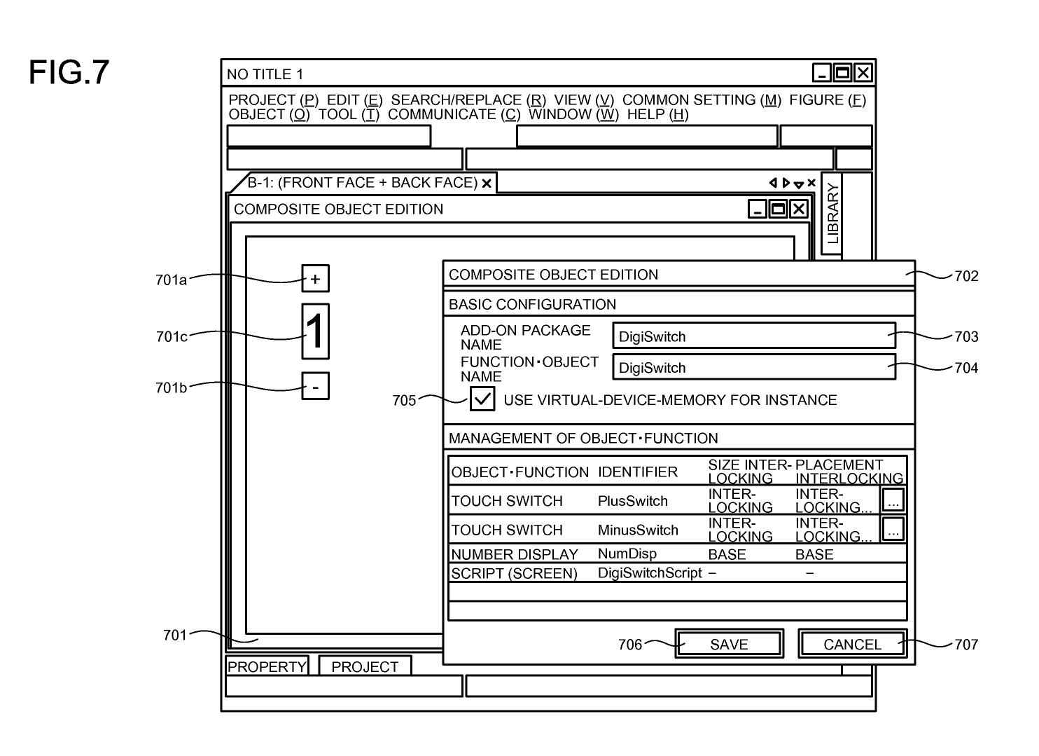

The control unit 401 entirely controls the units of the drawing device 400. The storage unit 410 has the drawing software 411 installed and stored therein. The operation unit 402 receives an activation instruction from the user and supplies the activation instruction to the control unit 401. According to the activation instruction, the control unit 401 reads the drawing software 411 from the storage unit 410, interprets contents of the drawing software 411, and processes and executes a function of the drawing software 411. For example, the control unit 401 displays a predetermined edition screen (a composite-object edition screen shown in FIG. 7, for example) on a display unit 403 according to the drawing software 411.

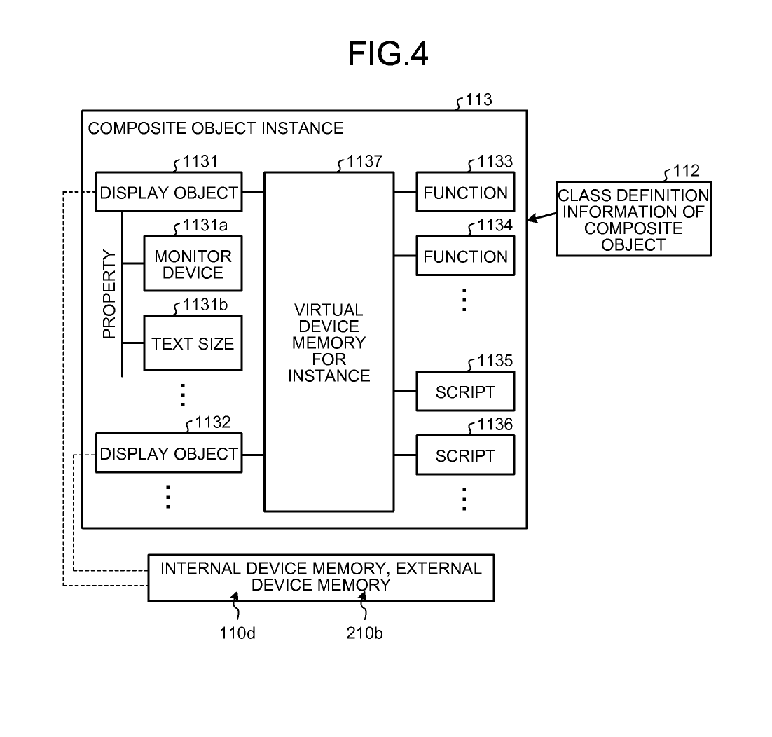

For example, the control unit 401 receives a generation instruction that specifies linking of a plurality of objects 1131 to 1136 (see FIG. 4) as one composite object, from the user via the operation unit 402 according to the drawing software 411. The control unit 401 links the objects 1131 to 1136 according to the generation instruction to be defined as one composite object, thereby generating class definition information 413 (generating step). That is, the drawing software 411 regards one composite object including the linked objects 1131 to 1136 as one class and generates the class definition information 413 that defines the class. At the same time, the control unit 401 updates the edition screen to reflect the generation instruction and displays the updated edition screen on the display unit 403, according to the drawing software 411.

The objects 1131 to 1136 include a plurality of display objects 1131 and 1132, a plurality of function objects 1133 and 1134, a plurality of script objects 1135 and 1136, and the like. Details of each object are explained later.

For example, the control unit 401 receives an edition instruction specifying a relation of the objects 1131 to 1136 from the user via the operation unit 402, according to the drawing software 411. The control unit 401 updates the class definition information 413 by adding information indicating the relation of the objects 1131 to 1136 according to the edition instruction. That is, the control unit 401 edits the class definition information 413 to define the relation of the objects 1131 to 1136 according to the edition instruction (editing step). At the same time, the control unit 401 updates the edition screen to reflect the edition instruction and displays the updated edition screen on the display unit 403, according to the drawing software 411.

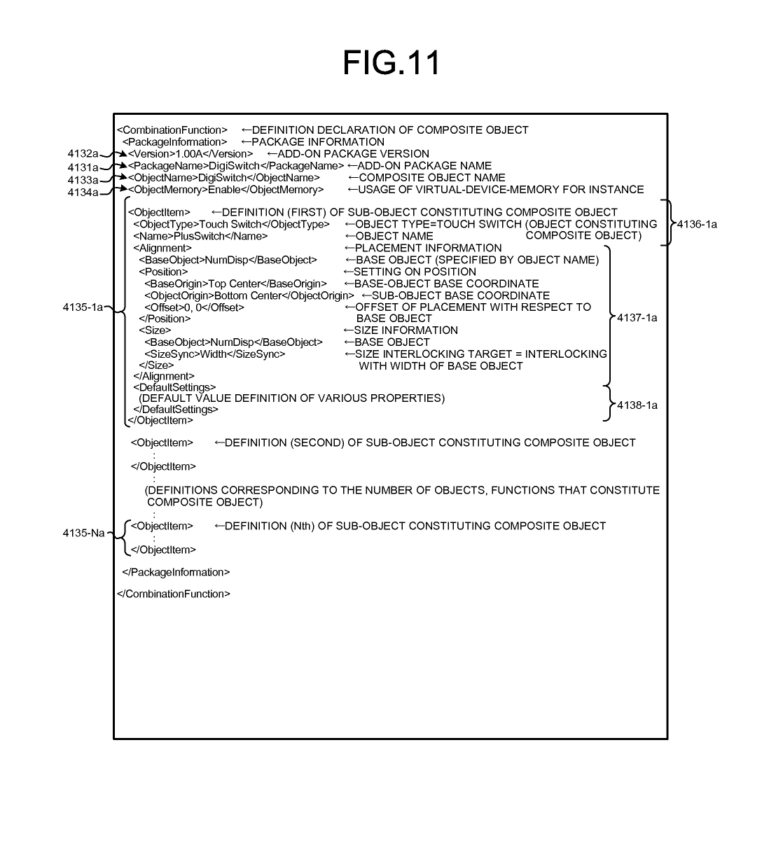

For example, the control unit 401 receives a confirmation instruction for confirming edition contents of the class definition from the user via the operation unit 402 and supplies the received instruction to the control unit 401, according to the drawing software 411. The control unit 401 confirms edition contents of the class definition information 413 according to the confirmation instruction, and automatically generates drawing data (XML data shown in FIG. 11, for example) including the confirmed class definition information 413. The control unit 401 also receives a placement instruction for placing the composite object on the screen from the user via the operation unit 402, according to the drawing software 411. The control unit 401 updates the drawing data (XML data) to specify a placement position of the composite object on the screen according to the placement instruction. That is, the control unit 401 creates drawing data 412 to be supplied to the programmable display device 100 to include the edited class definition information 413 and stores the created drawing data 412 in the storage unit 410 (creating step).

The operation unit 402 receives a transmission instruction specifying transmission of the drawing data to the programmable display device 100 from the user and supplies the transmission instruction to the communication processing unit 404 via the control unit 401. The communication processing unit 404 reads the drawing data 412 including the class definition information 413 from the storage unit 410 via the control unit 401 and transmits the read drawing data 412 to the programmable display device 100.

An internal configuration of the programmable display device 100 is explained with reference to FIG. 2.

The programmable display device 100 includes a control unit 101, a communication processing unit 102, an internal memory 110, a display screen 106 with a touch panel, an input control unit 105, a drawing-data processing unit 103, a display control unit 104, and a communication processing unit 107.

The control unit 101 entirely controls the units of the programmable display device 100. The communication processing unit (acquisition unit) 102 receives the drawing data transmitted from the drawing device 400 and temporarily stores the received data in a nonvolatile memory (such as a Flash ROM) included in the programmable display device 100. The programmable display device 100 reads the drawing data from the nonvolatile memory as appropriate and stores the read drawing data in a storage area 110a of the internal memory 110. The internal memory 110 is a storage element (a memory such as a RAM) for a user (a screen designer) to freely store therein or refer to values, and the storage area 110a is a static storage area in the internal memory 110. In this case, the storage area 110a of the internal memory 110 has drawing data 111 created by the user (the screen designer) via the drawing device 400 stored therein. The drawing data 111 includes class definition information 112 of one composite object linked with the objects 1131 to 1136 (see FIG. 4).

A storage area 110d of the internal memory 110 has an internal device memory 115 stored therein. The storage area 110d is a storage area in the internal memory 110. The internal device memory 115 can be used when information (data) is to be shared by objects, and the like.

The display screen 106 with a touch panel functions as both of a display unit 1061 and an input unit 1062, and displays graphics and texts, detects a portion operated by the operator on the display screen, and inputs input information corresponding to the operated portion to the programmable display device 100. The input control unit 105 determines the input information from the display screen 106 with a touch panel and supplies the input information to the control unit 101. For example, the input control unit 105 determines the input information from the display screen 106 with a touch panel as an activation instruction for the drawing data 111 and supplies the activation instruction for the drawing data 111 to the drawing-data processing unit 103 via the control unit 101.

The drawing-data processing unit (instance generation unit) 103 reads the drawing data 111 from the internal memory 110 via the control unit 101 according to the activation instruction for the drawing data, interprets the read drawing data 111, generates a composite object instance 113 according to the interpretation result, and stores the generated composite object instance 113 in a storage area 110b of the internal memory 110 via the control unit 101. The storage area 110b is a dynamic storage area in the internal memory 110. That is, the drawing-data processing unit 103 generates the composite object instance 113 and allocates the dynamic storage area 110b in the internal memory 110 to the generated composite object instance 113 to store the composite object instance 113 in the storage area 110b, according to the class definition information 112 included in the drawing data 111.

The display control unit 104 reads the generated composite object instance 113 from the internal memory 110 via the control unit 101, and generates screen data 114 corresponding to the composite object according to the generated composite object instance 113 to be stored in a storage area 110c in the internal memory 110 via the control unit 101. The storage area 110c is a dynamic storage area in the internal memory 110. At the same time, the display control unit 104 displays a screen corresponding to the screen data 114, that is, a screen corresponding to the composite object (a screen including a plurality of display objects 1131a, 1132a, 1132b, and 1134a shown in FIG. 15, for example) on the display unit 1061 according to the generated composite object instance 113.

At that time, the display control unit 104 reads device data from the PLC 200 via the control unit 101 and the communication processing unit 107 and generates the screen data 114 to cause the screen data 114 to include the device data. For example, the device data includes data D1000, M1000, and X1000 of the devices 301, 302, and 303, respectively, stored in a device memory in the PLC 200, that is, an external device memory 210 for the programmable display device 100.

When receiving an end instruction for drawing data via the input unit 1062 and the input control unit 105, the drawing-data processing unit 103 accesses the storage area 110b in the internal memory 110 via the control unit 101 and deletes the composite object instance 113 from the storage area 110b.

An internal configuration of the PLC 200 is explained with reference to FIG. 2.

The PLC 200 includes a control unit 201, a communication processing unit 202, the external device memory 210 (for the programmable display device 100), and a communication processing unit 203.

The control unit 201 entirely controls the units of the PLC 200. The communication processing unit 202 receives a predetermined signal from the devices 301 to 303 or transmits a predetermined control signal to the devices 301 to 303. The data D1000, M1000, and X1000 of the devices 301, 302, and 303 is stored in a storage area 210a of the external device memory 210.

The device 301 is, for example, a temperature sensor installed in a factory line, which measures a temperature at a predetermined position in the factory line and inputs the measured temperature to the PLC 200. The device 302 is, for example, a lamp installed in a factory line, which is lighted when a predetermined condition is met. The device 303 is, for example, a switch installed in a factory line, which is switched on/off when a predetermined condition is met.

For example, the communication processing unit 202 receives the measured temperature input from the device (a temperature sensor) 301 and stores the measured temperature as the data D1000 of the device 301 in the external device memory 210 via the control unit 201. The control unit 201 transmits the data (the measured temperature) D1000 of the device 301 to the programmable display device 100 via the communication processing unit 203. For example, the programmable display device 100 executes the script object 1136 included in the composite object instance 113 as shown in FIG. 6, and turns the data M1000 of the device 302 ON to rewrite the data M1000 of the device 302 in the external device memory 210 when the data (the measured temperature) D1000 exceeds a threshold (10 (° C.), for example). The control unit 201 then generates a control signal corresponding to the data M1000 of the device 302 in the external device memory 210 and supplies the control signal to the device 302 (a lamp) via the communication processing unit 202. This lights the device (the lamp) 302. In this way, for example, workers in a factory line can be informed that a temperature at a predetermined position in the factory line becomes high and exceeds a threshold.

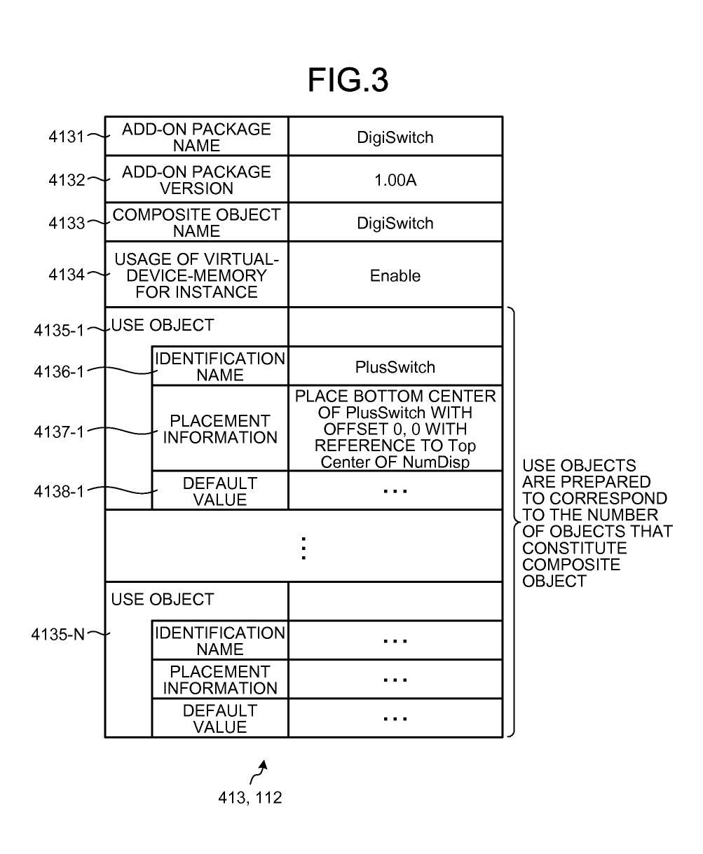

The class definition information of the composite object is explained with reference to FIG. 3. FIG. 3 depicts a data configuration of the class definition information of the composite object. Because the class definition information 413 and the class definition information 112 has the same data configuration, the data configuration of the class definition information 413 is mainly explained below.

The class definition information 413 of the composite object has an add-on package name 4131, an add-on package version 4132, a composite object name 4133, usage of virtual-device memory for instance 4134, and a plurality of use objects/functions 4135-1 to 4135-N.

The add-on package name 4131 is the name of an add-on package for using the composite object and is used when a plurality of composite objects are collectively called up as candidates to be added-on (imported) in the drawing software 411, and the like. The add-on package name 4131 corresponds to an attribute in a class of the composite object. The add-on package name 4131 is “DigiSwitch”, for example.

The add-on package version 4132 is the version of the add-on package. The add-on package version 4132 is “1.00A”, for example.

The composite object name 4133 is the name for identifying the composite object. The composite object name 4133 corresponds to a class name in the class of the composite object. The composite object name 4133 is “DigiSwitch”, for example.

The usage of virtual-device-memory for instance 4134 is information for specifying whether a virtual device memory for instance is used in the composite object. The usage of virtual-device-memory for instance 4134 is “Enable”, for example. In the explanations of the drawing device 400, a case where the use of the virtual device memory for instance is specified as “Enable” is explained.

The use objects 4135-1 to 4135-N are prepared to correspond to the number (N, for example) of objects to be included in the composite object. The use objects 4135-1 to 4135-N are each information for defining objects to be used in the composite object and have an identical data configuration. For example, the use object 4135-1 has an identification name 4136-1, placement information 4137-1, and a default value 4138-1.

The identification name 4136-1 is the name for identifying an individual object. The identification name 4136-1 corresponds to an attribute in the class of the composite object. The identification name 4136-1 is “PlusSwitch”, for example.

The placement information 4137-1 is information that defines a positional relation of the own object relative to another object. The placement information 4137-1 corresponds to a method in the class of the composite object. The placement information 4137-1 is “Place Bottom Center of PlusSwitch with an offset 0, 0 with reference to Top Center of NumDisp”, for example.

The default value 4138-1 is information that specifies default values of various properties associated with the own object as explained later. The default value 4138-1 corresponds to a method in the class of the composite object.

A configuration of the composite object instance 113 generated in the dynamic storage area 110b in the internal memory 110 shown in FIG. 2 is explained with reference to FIG. 4. FIG. 4 depicts a configuration of the composite object instance 113 generated in the storage area 110b.

The composite object instance 113 includes the objects 1131 to 1136 and a virtual device memory for instance 1137.

The objects 1131 to 1136 include the display objects 1131 and 1132, the function objects 1133 and 1134, the script objects 1135 and 1136, and the like. The display objects 1131 and 1132 are display objects that are to be parts of a screen (see FIG. 15), respectively. The function objects 1133 and 1134 are objects of functions associated with the display objects 1131 and 1132. The script objects 1135 and 1136 are objects of scripts that specify operations of the display objects 1131 and 1132 and the function objects 1133 and 1134.

The display object 1131 corresponds to the display object 1131a (see FIG. 15) for displaying the temperature measured by the device (the temperature sensor) 301, for example. For example, a monitor device 1131a and a text size 1131b are associated with the display object 1131 as properties (setting information) for the display. The monitor device 1131a is, for example, information indicating a target to be monitored (observed) in the device (the temperature sensor) 301. The text size 1131b is information indicating the size of texts to be displayed.

The display object 1132 corresponds to switches 1132a and 1132b (see FIG. 15) for scrolling a graph 1133a, for example. Although not shown, predetermined properties (setting information) are also associated with the display object 1132.

The function object 1133 corresponds to a logging function to acquire log information of the temperature measured by the device (the temperature sensor) 301, for example. The function object 1133 can be, for example, an alarm display function to perform a search and display an alarm at a time when a predetermined trigger is established, or can be an operation-log display function to acquire log information of an operation performed to the programmable display device 100 by an operator and display the acquired log information.

The function object 1134 can be a historical-trend-graph display function to generate the graph 1134a (see FIG. 15) from the log information of the measured temperature acquired by the function object (the logging function) 1133 and display the graph 1134a, for example.

The script object 1135 can be a script specifying that the display object 1132 (that is, the switches 1132a and 1132b) is blinked when the temperature (D1000) measured by the device (the temperature sensor) 301 exceeds a threshold (10° C.), for example.

The script object 1136 can be a script as shown in FIG. 6, for example. The script shown in FIG. 6 can be a script specifying that the device (the lamp) 302 is lighted when the temperature (D1000) measured by the device (the temperature sensor) 301 exceeds the threshold (10° C.)

The virtual device memory for instance 1137 is a virtual device memory dynamically generated in the composite object instance 113 when the composite object instance 113 is generated. That is, when the composite object instance 113 is generated, a part of the dynamic storage area 110b in the internal memory 110 is allocated to the virtual device memory for instance 1137. The virtual device memory for instance 1137 is cross-referred when data is transferred among the objects 1131 to 1136.

For example, when the function object (the logging function) 1133 acquires the log information of the temperature measured by the device (the temperature sensor) 301, data of the measured temperature is supplied from the display object 1131 to the function object (the logging function) 1133 via the virtual device memory for instance 1137.

Alternatively, for example, when the function object (the historical-trend-graph display function) 1134 generates a graph, the log information of the measured temperature is supplied from the function object (the logging function) 1133 to the function object (the historical-trend-graph display function) 1134 via the virtual device memory for instance 1137.

Alternatively, for example, when the script object 1135 executes processing of a script, the data of the measured temperature is supplied from the display object 1131 to the script object 1135 via the virtual device memory for instance 1137. After the processing of the script is executed, information indicating that the switches 1132a and 1132b are to be blinked is supplied from the script object 1135 to the display object 1132 via the virtual device memory for instance 1137.

Alternatively, for example, when the script object 1136 executes processing of a script, the data of the measured temperature is supplied from the display object 1131 to the script object 1136 via the virtual device memory for instance 1137.

The virtual device memory for instance 1137 is accessible from the objects 1131 to 1136 included in the composite object instance 113 and is inaccessible from other instances.

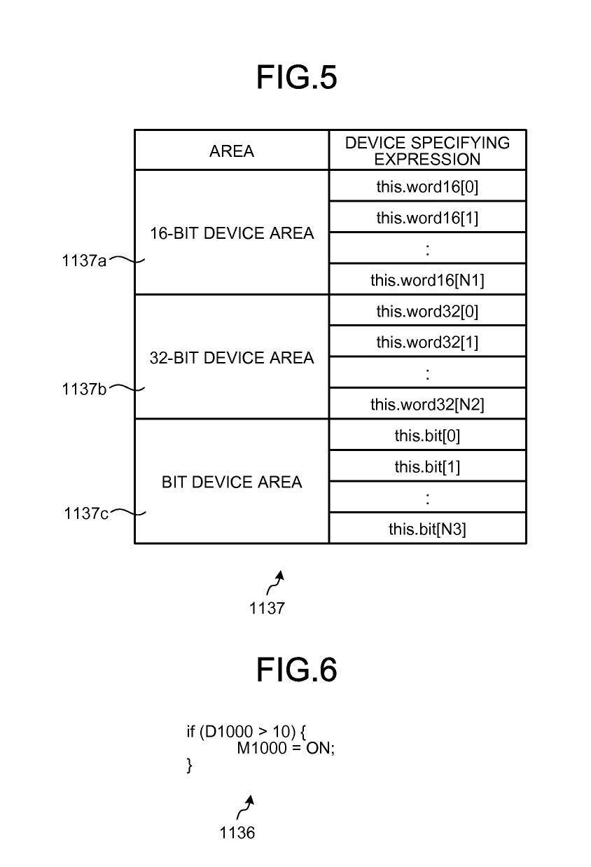

A configuration of the virtual device memory for instance 1137 is explained with reference to FIG. 5. FIG. 5 depicts a configuration of the virtual device memory for instance 1137.

The virtual device memory for instance 1137 has a 16-bit device area 1137a, a 32-bit device area 1137b, and a bit device area 1137c.

The 16-bit device area 1137a is an area used to transfer data with a data length of 16 bits. For example, the temperature measured by the device (the temperature sensor) 301 is suitable for being represented by data of 16 bits and therefore transferred via the 16-bit device area 1137a. Specifically, the 16-bit device area 1137a is specified by an array of this.word16[0] to this.word16[N1] having consecutive virtual addresses 0 to N1. That is, a transferer of data specifies one of the virtual addresses 0 to N1 and assigns the data to be transferred to an array element with the specified one of the virtual addresses 0 to N1 as a suffix. A receiver of the data receives the data by referring to the array element at the specified virtual address.

In the example mentioned above, when the function object (the logging function) 1133 acquires the log information of the temperature measured by the device (the temperature sensor) 301, the display object 1131 specifies the virtual address 0 and assigns the value of the measured temperature as follows.

this.word16[0]=20.5 (° C.)

The function object (the logging function) 1133 then receives the data “20.5 (° C.)” of the measured temperature by referring to this.word16[0].

Similarly, the 32-bit device area 1137b is specified by an array of this.word32[0] to this.word32[N2] having consecutive virtual addresses 0 to N2. That is, a transferer of data specifies one of the virtual addresses 0 to N2 and assigns the data to be transferred to an array element with the specified one of the virtual addresses 0 to N2 as a suffix. A receiver of the data receives the data by referring to the array element at the specified virtual address.

Similarly, the bit device area 1137b is specified by an array of this.word[0] to this.word[N3] having consecutive virtual addresses 0 to N3. For example, the ON/OFF state of the device (the lamp) 302 is suitable for being represented by data of one bit and therefore transferred via the bit device area 1137b. That is, a transferer of data specifies one of the virtual addresses 0 to N3 and assigns the data to be transferred to an array element with the specified one of the virtual addresses 0 to N3 as a suffix. A receiver of the data receives the data by referring to the array element at the specified virtual address.

The class definition of the composite object can be described as a member variable of the class (the object) represented by the composite object name. In this case, the member variable is automatically allocated from the head of the virtual device memory for instance when the object is instantiated. This allocation of the member variable to the virtual device memory for instance can be performed on the side of a firmware of the programmable display device 100 during instance generation or can be performed when the object is instantiated by the drawing software in the drawing device 400.

While “this” in the array name indicates the own instance, it can be omitted when other instances are not referred to.

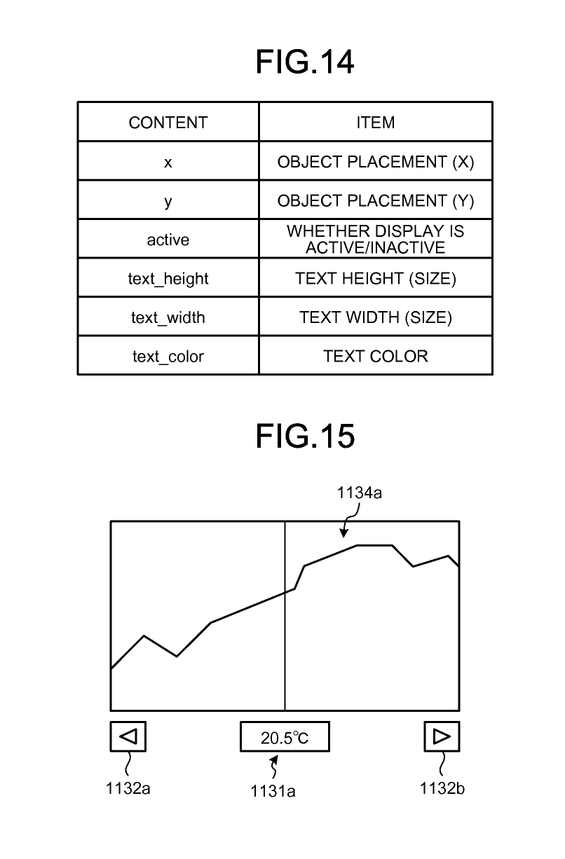

Properties associated with the display object are explained with reference to FIG. 14.

Individual objects and functions in the composite object are identified by identification names of the use objects and functions, and property names thereof are handled as virtual devices.

A character string for identifying a property (an attribute) of an object is allocated as a property name as shown in FIG. 14. As the identification name of each property,

this.(object identification name).(property name) is used. This enables the text size of, for example, a display object A to be changed in a script based on a device value. That is, when the identification name of the display object A is Obj_A, the following description is added to the script.

this.Obj_A.text_height=[w:GD1000]; With this description, the text height of the display object A can be set to be the same as that of [GD1000]. Alternatively, the following description is added to the script.

this.Obj_A.text_width=[w:GD1001]; With this description, the text height of the display object A can be set to be the same as that of [GD1001]. Alternatively, the following description is added to the script.

Alternatively, the text size or color of the display object A can be changed in the script to conform to a display object B. That is, when the identification name of the display object A is Obj_A and the identification name of the display object B is Obj_B, the following description is added to the script.

this.Obj_A.text_height=this.Obj_B.text_height; With this description, the text height of the display object A can be set to the same as that of the display object B. Alternatively, the following description is added to the script.

this.Obj_A.text_width=this.Obj_B.text_width; With this description, the text width of the display object A can be set to the same as that of the display object B. Alternatively, the following description is added to the script.

this.Obj_A.text_color=this.Obj_B.text_color; With this description, the text color of the display object A can be set to the same as that of the display object B.

A processing timing of changing the properties of the objects included in the composite object by using the script can be periodic, for example. In such a case, the procedure is performed in an order of composite-object update request (normally periodically occurring)→script processing execution→object update. In this way, the processing timing for the script in the composite object is executed synchronously with the update process for the composite object. That is, update of the composite object is performed in a lump.

The script processing in the programmable display device is generally performed asynchronously with update of object drawing.

Meanwhile, there is a function of an object script of the programmable display device. In this case, a function to execute a script at the update timing of object drawing as mentioned above is included. This object script is independent of each of individual objects (corresponding to Obj_A and Obj_B, for example) and therefore cannot access other objects included in the composite object. Because the individual objects are subjected to the update process with respect to each object in turn, process results of the script cannot be reflected on a plurality of objects at the same time.

On the other hand, the present embodiment can solve the problem mentioned above by enabling an access to properties of objects included in a composite object from a script or other objects constituting the composite object and by processing update of the composite object and also of a script that controls the composite object synchronously in a lump.

A method for creating the drawing data 412, which is executed by the drawing software 411 in the drawing device 400, is explained with reference to FIGS. 7 to 10.

In the drawing software 411, a mechanism that reads a screen (dialog) definition to perform a setting for a composite object definition, interprets the screen definition, and sets or displays the screen definition is provided. When a composite object is used in drawing data and there is a corresponding add-on, a setting can be performed with the add-on. When there is no corresponding add-on, it is considered that the composite object is movable but uneditable. Uneditability is notified with an error dialog or the like.

In the drawing software 411, a function (a tool) to support creation of a composite object is prepared (hereinafter, “composite-object design tool”). The composite-object design tool can place or set functions of objects, scripts, and the like, which can be used in the programmable display device 100.

When a plurality of objects are placed, with respect to one object 1001 as a base, a relation of placement or of the sizes of other objects (sub-objects) 1002 can be set as shown in FIG. 10.

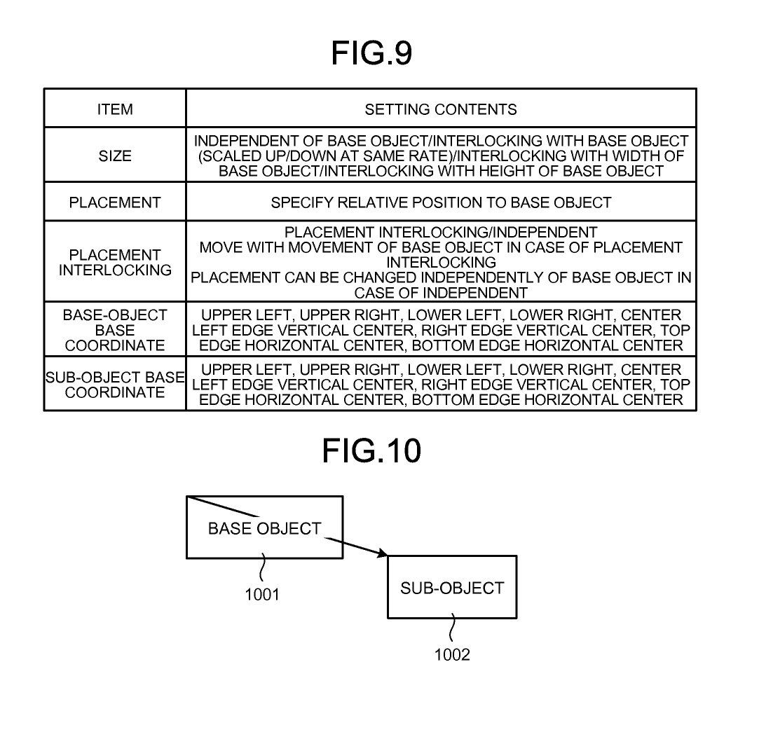

Specifically, a base coordinate of the sub-object 1002 can be specified as a relative coordinate to a base coordinate of the base object 1001. While a case where the base coordinate of the sub-object 1002 is “upper left” is illustrated in FIG. 10, the base coordinate can be other positions as shown in FIG. 9. While the case where the base coordinate of the base object 1001 is “upper left” is illustrated in FIG. 10, the base coordinate can be other positions as shown in FIG. 9.

Whether a placement relation between the base object 1001 and the sub-object 1002 is interlocking or independent is specified (placement editing step). For example, when “interlocking” is specified for “placement interlocking” shown in FIG. 9, the sub-object 1002 shown in FIG. 10 moves with movement of the base object 1001. When “independent” is specified for the “placement interlocking” shown in FIG. 9, the relative coordinate of the sub-object 1002 shown in FIG. 10 can be arbitrarily changed.

Whether the sizes of the base object 1001 and the sub-object 1002 are interlocking or independent is specified (size editing step). For example, when “interlocking with base object” is specified for the “size” shown in FIG. 9, the sub-object 1002 shown in FIG. 10 is scaled up/down at the same rate as that of scaling-up/down of the base object 1001. For example, when “interlocking with width of base object” is specified for the “size” shown in FIG. 9, the sub-object 1002 shown in FIG. 10 has the width scaled up/down at the same rate as that of scaling-up/down of the width of the base object 1001. For example, when “interlocking with height of base object” is specified for the “size” shown in FIG. 9, the sub-object 1002 shown in FIG. 10 has the height scaled up/down at the same rate as that of scaling-up/down of the height of the base object 1001. For example, when “independent of base object” is specified for the “size” shown in FIG. 9, the size of the sub-object 1002 shown in FIG. 10 can be arbitrarily changed.

For example, a specific procedure of the creation method for the drawing data 412 is as follows.

When the composite-object design tool is started, a composite-object edition screen 701 and a composite-object edition dialog 702 shown in FIG. 7 are displayed on the display unit 403 of the drawing device 400. For example, “DigiSwitch” is input to a field 703 of the composite-object edition dialog 702 as an add-on package name. Furthermore, for example, “DigiSwitch” is input to a field 704 as a function/object name.

An operation of selecting, for example, “object addition” from the menu is then performed, thereby placing various objects 701a to 701c to be used in the composite object within the composite-object edition screen 701. In this case, objects in the composite object are referred to as component objects. An operation such as an operation of selecting, for example, “script addition” from the menu is performed, thereby adding necessary scripts. Constituent elements such as the added component objects and scripts are added in a list and displayed on the composite-object edition dialog 702.

Identification names are then assigned to the component objects and scripts. That is, identification names (character strings) for the component objects and scripts are input and specified in the composite-object edition dialog 702.

A positional relation of the component objects is then defined. That is, a component object the positional relation of which is to be defined is selected in the composite-object edition dialog 702 and whether the own object becomes a base or another object is used as a base is specified.

When another object is used as a base, the target component object is specified and the interlocking methods as shown in FIG. 9 are specified.

Whether to use a virtual device memory for instance is specified. For example, a checkbox 705 is clicked to set to use a virtual device memory for instance when information is to be shared (that is, when data is to be transferred) among the component objects or script.

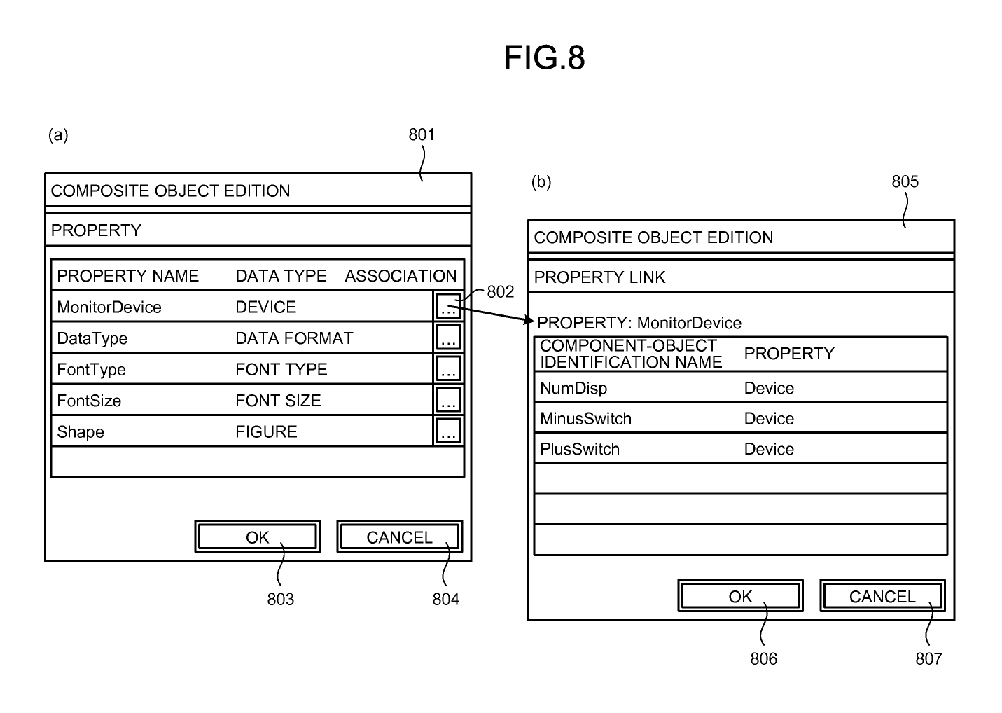

Allocation of composite object properties and properties of the component objects is then performed. For example, an operation of selecting “property definition” from the menu is performed, thereby displaying a property definition dialog 801 shown in FIG. 8(a) on the display unit 403 of the drawing device 400.

With the property definition dialog 801, types of properties used for the composite object and the property names are defined. When an OK button 803 in the property definition dialog 801 is pushed, edition contents are confirmed. When a cancel button 804 is pushed, the edition contents are canceled.

The properties of the component objects are then linked to each of the composite object properties. For example, when a bottom 802 for a property “MonitorDevice” in the property definition dialog 801 is clicked, a property linking dialog 805 as shown in FIG. 8(b) is displayed. For example, an operation of selecting “object addition” from the menu is performed, thereby displaying a display object with which the property “MonitorDevice” is to be associated in the property linking dialog 805. When an OK button 806 in the property linking dialog 805 is pushed, edition contents are confirmed. When a cancel button 807 is pushed, the edition contents are canceled.

For example, when a save button 706 on the composite-object edition screen 701 shown in FIG. 7 is pushed after the settings mentioned above are completed, edition contents of the class definition are confirmed and XML data as shown in FIG. 11 is automatically generated as the drawing data 412. That is, a block of definition declarations of the composite object from <PackageInformation> to </PackageInformation> is generated. This block is information as the class definition information 413 of the composite object. When a cancel button 707 is pushed on the composite-object edition screen 701 shown in FIG. 7, edition contents of the class definition are canceled.

In the XML data shown in FIG. 11, a description 4132a corresponds to the add-on package version 4132 (see FIG. 3). A description 4131a corresponds to the add-on package name 4131 (see FIG. 3). A description 4133a corresponds to the composite object name 4133 (see FIG. 3). A description 4134a corresponds to the usage of virtual-device-memory for instance 4134 (see FIG. 3).

Descriptions 4135-1a to 4135-Na correspond to the use objects 4135-1 to 4135-N (see FIG. 3), respectively. In the description 4135-1a, a description 4136-1a corresponds to the identification name 4136-1 (see FIG. 3). A description 4137-1a corresponds to the placement information 4137-1 (see FIG. 3). A description 4138-1a corresponds to the default value 4138-1 (see FIG. 3).

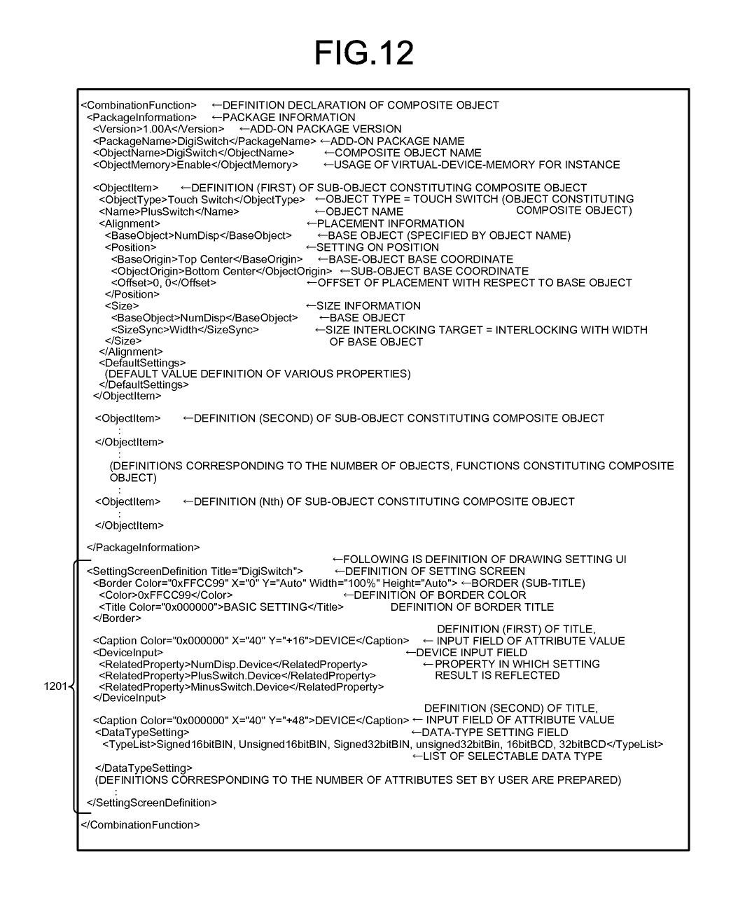

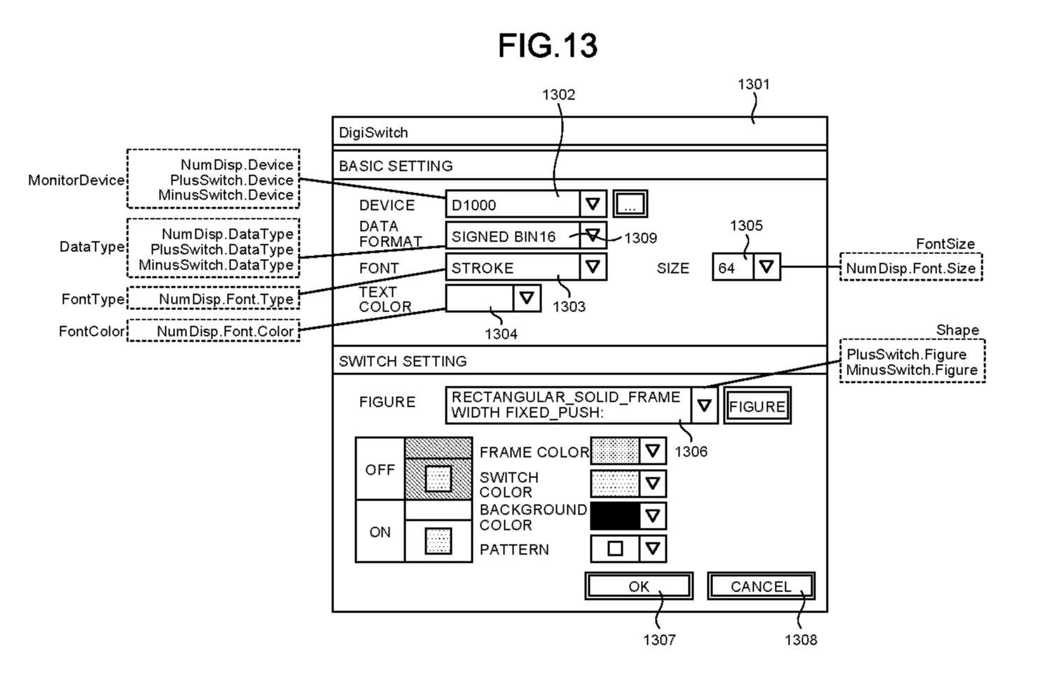

A method of changing various properties associated with a display object from default values is explained with reference to FIGS. 12 and 13.

For the XML data automatically generated as mentioned above, a block 1201 from <SettingScreenDefinition> to </SettingScreenDefinition> for defining a drawing-setting user-interface screen is added as shown in FIG. 12. This is created by using a screen design tool similar to an HTML editor or by a text editor.

For example, basic parts such as a combo box and a title are prepared. Basic constituent elements such as a checkbox and a preview can be freely placed. A setting common to a plurality of objects can be allocated to each setting field. As for a setting item, a target in which a setting value in the item is reflected can be specified by “identification name+property name” of the corresponding object.

For example, in <Deviceinput> to </Deviceinput> indicating device input fields, NumDisp.Device, PlusSwitch.Device, and MinusSwitch.Device are specified as targets in which setting values are reflected. This enables simultaneous reflection of one setting item in a plurality of objects.

For example, an operation of selecting “property edition” from the menu is then performed, thereby displaying a property edition screen 1301 shown in FIG. 13 on the display unit 403 of the drawing device 400.

When the device to be monitored is changed to “D1000” in a device field 1302 of the property edition screen 1301, the devices for the three display objects NumDisp, PlusSwitch, and MinusSwitch are changed to “D1000” in a lump.

When the data format is changed to “signed BIN16” in a data format field 1309, the data formats of the three display objects NumDisp, PlusSwitch, and MinusSwitch are changed to “signed BIN16” in a lump.

When the font is changed to “stroke” in a font field 1303, the font of one display object NumDisp is changed to “stroke”.

When the text color is changed to “white” in a text color field 1304, the text color of one display object NumDisp is changed to “white”.

When the font size is changed to “64” in a size field 1305, the font size of one display object NumDisp is changed to “64”.

When the figure is changed to “rectangular_solid_frame border fixed_push” in a figure field 1306, the figures of two display objects PlusSwitch and MinusSwitch are changed to “rectangular_solid_frame border fixed_push” in a lump.

When an OK button 1307 on the property edition screen 1301 is pushed, edition contents are confirmed. When a cancel button 1308 is pushed, the edition contents are canceled.

As described above, in the drawing-data creation method according to the present embodiment, the drawing device 400 generates the class definition information 413 by linking a plurality of objects and defining the linked objects as one composite object, and edits the generated class definition information 413 to specify a relation of the objects. The drawing data 412 including the edited class definition information 413 is then created. This provides a mechanism that interlocks existing functions to construct a new function. That is, a function that can be realized by a combination of a plurality of existing objects can be easily set on a user side.

In the drawing-data creation method according to the present embodiment, whether a placement relation of a base display object and a sub-display object is interlocking or independent is specified. Whether the sizes of the base display object and the sub-display object are interlocking or independent is also specified. Accordingly, changes in the placement and the sizes of the display objects can be easily set on the user side.

In the drawing-data creation method according to the present embodiment, placement of the sub-display object is specified by a relative coordinate to the base display object. This enables an easy setting of placement of a plurality of display objects on the user side.

The programmable display device 100 according to the present embodiment receives the drawing data 412 including the class definition information 413 from the drawing device 400, generates the composite object instance 113 according to the class definition information 112 (class definition information 413), and displays a screen corresponding to the composite object on the display unit 1061 according to the generated composite object instance 113. As described above, the programmable display device 100 has a configuration suitable for the drawing-data creation method as mentioned above and performs an operation suitable for the drawing-data creation method. That is, according to the present embodiment, a programmable display device suitable for setting a function that can be realized by a combination of a plurality of existing objects easily on the user side can be provided.

A case where the composite object instance 113 generated in the manner as mentioned above does not have the virtual device memory for instance 1137 in the programmable display device 100 is now considered. In this case, for example, to transfer data from the display object 1131 to the display object 1132, the display object 1131 needs to temporarily store the data in the internal device memory 115 or a space area 110e in the internal memory 110 or in a space area 210b in an external device memory as shown by broken lines in FIG. 4, and thus the display object 1132 needs to acquire the data by referring to the internal device memory 115 or the space area 110e in the internal memory 110 or to the space area 210b in the external device memory. Accordingly, the internal device memory 115 or the space area 110e in the internal memory 110 or the space area 210b in the external device memory is consumed by the data to be transferred from the display object 1131 to the display object 1132, that is, by intermediate data. If another screen is created assuming that a user refers to the internal memory 110, it is difficult to perform an address change later.

On the other hand, in the programmable display device 100 according to the present embodiment, the generated composite object instance 113 has the virtual device memory for instance 1137. Accordingly, as a device memory used for performing exchange among plural functions or objects in a composite object, a memory independent of the space area 110d in the internal device memory and the like and specific to each instance of the object can be used. This prevents consumption of the internal device memory 115 or the space area 110e in the internal device 100. Furthermore, because addresses in the virtual device memory for instance 1137 are virtual addresses, an address change can be easily performed.

While a case where one instance is generated from a class definition of a composite object has been explained in the above embodiment, a plurality of instances can be generated from the class definition of the composite object. Also in this case, the virtual device memory for instance 1137 is generated in each of the instances.

While the class definition of one composite object has been explained in the above embodiment, there can be class definitions of a plurality of composite objects and a plurality of instances corresponding to the class definitions can be generated.

### INDUSTRIAL APPLICABILITY

As described above, the programmable display device according to the present invention is useful for controlling a plurality of devices.

### REFERENCE SIGNS LIST

10 control system

100 programmable display device

101 control unit

102 communication processing unit

103 drawing-data processing unit

104 display control unit

105 input control unit

106 display screen with touch panel

107 communication processing unit

110 internal device

110a to 110c storage area

110d space area

111 drawing data

112 class definition information

113 composite object instance

114 screen data

200 PLC

201 control unit

202 communication processing unit

203 communication processing unit

210 external device memory

210a storage area

210b space area

301 to 303 device

400 drawing device

401 control unit

402 operation unit

403 display unit

410 storage unit

411 drawing software

412 drawing data

413 class definition information

1061 display unit

1062 input unit

1. A programmable display device that is connected to a control device controlling a plurality of devices, and functions as a user interface for the control device, the programmable display device comprising:
an acquisition unit that acquires drawing data including class definition information automatically generated according to an instruction of a user of the programmable display device to link a plurality of objects linked as one composite object;
an instance generation unit that generates a composite object instance according to the class definition information; and
a display control unit that displays a screen corresponding to the composite object on a display unit according to the generated composite object instance, wherein
the generated instance includes
the plurality of objects, and
a virtual device memory for instance that is cross-referenced when data is transferred among the objects,
the class definition information includes
a plurality of pieces of object identification information for identifying the objects to each other,
a plurality of properties that indicate attributes of the objects,
a plurality of pieces of interlocking information that specify interlocking operations of the objects at a time of a property change, and
virtual-device memory use information that indicates whether to use the virtual device memory for instance,
each of the plural pieces of interlocking information includes an interlocking-target specification information that specifies another object serving as an interlocking target associated with a change of an own property,
the instance generation unit generates the composite object instance by connecting the objects and incorporating the connected objects in one instance via the virtual device memory for instance when the virtual-device memory use information indicates that the virtual device memory for instance is used,
the virtual device memory for instance is a virtual memory that is cross-referred when data is transferred among the objects,
the virtual device memory for instance is a placement element having a virtual address as a suffix,
the virtual device memory for instance is configured not to be accessible from outside of the generated instance,
the automatically-generated class definition information is described in a markup language, and
a block for defining a drawing-setting user-interface screen is further added to the automatically-generated class definition information in a markup language.

2. The programmable display device according to claim 1, wherein
the plurality of objects include
a plurality of display objects that are to be parts of the screen, respectively,
a function object related to the display objects, and
a script object that specifies operations of the display objects or an operation of the function object.

3. A drawing-data creation method of creating drawing data to be executed in a programmable display device that is connected to a control device controlling a plurality of devices and functions as a user interface for the control device, the creation method comprising:
a generating step of generating class definition information by linking a plurality of objects and defining the linked objects as one composite object, according to an instruction of a user of the programmable display device;
an editing step of editing the generated class definition information to specify a relation of the objects; and
a creating step of creating drawing data to be supplied to the programmable display device to include the edited class definition information, wherein
the class definition information includes
a plurality of pieces of object identification information for identifying the objects to each other,
a plurality of properties that indicate attributes of the objects,
a plurality of pieces of interlocking information that specify interlocking operations of the objects at a time of a property change, and
virtual-device memory use information that indicates whether to use a virtual device memory for instance that is cross-referenced when data is transferred among the objects,
each of the plural pieces of interlocking information includes an interlocking-target specification information that specifies another object serving as an interlocking target associated with a change of an own property,
the virtual-device memory use information is information for generating a composite object instance by connecting the objects and incorporating the connected objects in one instance via the virtual device memory for instance when the virtual-device memory use information indicates that an instance generation unit of the programmable display device uses the virtual device memory for instance,
the virtual device memory for instance is a virtual memory that is cross-referred when data is transferred among the objects,
the instance virtual device memory is a placement element having a virtual address as a suffix,
the instance virtual device memory is configured not to be accessible from outside of the generated instance, and
the automatically-generated class definition information is described in a markup language,
the drawing-data creation method further comprising
an adding step in which a block for defining a drawing-setting user-interface screen further adds a markup language to the automatically-generated class definition information.

4. The drawing-data creation method according to claim 3, wherein
the plurality of objects include a plurality of display objects that are to be parts of a screen displayed by the programmable display device, and
the editing step includes
a placement editing step of specifying whether a placement relation between a first display object and a second display object is interlocking or independent, and
a size editing step of specifying whether sizes of the first display object and the second display object are interlocking or independent.

5. The drawing-data creation method according to claim 4, further comprising:
an acquiring step in which the programmable display device acquires the drawing data including the class definition information;
a second generating step in which the programmable display device generates a composite object instance according to the class definition information, and
a displaying step in which the programmable display device displays a screen corresponding to the composite object on a display unit according to the generated composite object instance, wherein
at the displaying step, the first display object and the second display object are displayed on the display unit based on the placement relation specified at the placement editing step and a relation of the sizes specified at the size editing step.

6. The drawing-data creation method according to claim 3, wherein
the plurality of objects include a plurality of display objects that are to be parts of a screen displayed by the programmable display device, and
placement of a first display object is specified by a relative coordinate to a second display object at the editing step.
